(19) United States
(12) Patent Application Publication
(10) Pub. No.: US 2012/0274058 A1
(43) Pub. Date: Nov. 1, 2012

(54) INTEGRABLE BOOKSTAND

(76) Inventor: Eran YAIR, Hertzelia (IL)

(21) Appl. No.: 13/095,923

(22) Filed: Apr. 28, 2011

(51) Int. Cl. B42D 1/00; A47B 23/00

(52) U.S. Cl. 281/15.1; 248/441.1; 248/447

(57) ABSTRACT

An integrable bookstand adapted to be integrated into a hard back cover of a book is disclosed. The integrable bookstand having a withheld and deployed conformations.

In the withheld conformation the bookstand is coplanar with the hard back cover, rendering the latter storable in tandem between other flat articles.

### TECHNICAL FIELD

In general, the present invention pertains to the arts of bookstands. In particular, the invention relates to an integral bookstand, having deployed and withheld conformations.

### BACKGROUND ART

It is believed that the pertinent state-of-the-art is represented by: U.S. patents Ser. No. 2375190, 2587316, 4377271 and 2256513; U.S. patent applications Ser. No. 2007295677, 2003057343 and 2005012016; GB patent application Ser. No. 872982; German patent application Ser. No. 102007033687; European patent application Ser. No. EP2203314 as well as by international patent applications having publication No. 9813215 and 2007069842.

### SUMMARY OF THE INVENTION

There is provided in accordance with embodiments of the present invention an integral bookstand.

There is further provided in accordance with embodiments of the present invention a method of using the integral bookstand.

There is yet further provided in accordance with embodiments of the present invention a method integrating a bookstand into the cover of a book.

There is still yet further provided in accordance with embodiments of the present invention a method conferring a support to a book by an integrable stand.

It should be understood, however, that the eclectically synopsized brief summary supra is not to limit the invention to the particular forms and examples, but on the contrary, is to cover all modifications, equivalents, and alternatives falling within the scope of the invention.

### DESCRIPTION OF THE DRAWINGS

The present invention will be understood and appreciated more comprehensively from the following detailed description taken in conjunction with the appended drawings in which:

FIG. 1A is an isometric view of an embodiment of the bookstand of the invention integrated into a book cover, in a withheld conformation;

FIG. 1B is an isometric view of an embodiment of the bookstand of the invention shown in FIG. 1, in a deployed conformation;

FIG. 1C is an exploded view of an embodiment of the bookstand of the invention shown in FIG. 1A and 1B;

FIG. 2A is an exploded view of an embodiment of the bookstand of the invention;

FIG. 2B is an isometric view of an embodiment of the bookstand of the invention, shown in FIG. 2A, in a deployed conformation;

FIG. 3A is an isometric view of the outer frame of the bookstand of the invention;

FIG. 3B is an enlarged view of a portion of the outer frame of the bookstand of the invention shown in FIG. 3A;

FIG. 3C is a front view of the outer frame of the bookstand shown in FIG. 3A;

FIG. 3D is a top view of the outer frame of the bookstand shown in FIG. 3A;

FIG. 3E is a front view of the outer frame of the bookstand shown in FIG. 3A;

FIG. 4 is an isometric view of the support member of the bookstand of the invention;

FIG. 5A is a perspective view of a preferred embodiment of the bookstand of the invention;

FIG. 5B is an exploded view of a preferred embodiment of the bookstand of the invention shown in FIG. 5A.

While the invention is susceptible to various modifications and alternative forms, specific embodiments thereof have been shown merely by way of example in the drawings. The drawings are not necessarily complete and components are not essentially to scale; emphasis instead being placed upon clearly illustrating the principles underlying the present invention.

### DETAILED DESCRIPTION OF EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with technology- or business-related constraints, which may vary from one implementation to another. Moreover, it will be appreciated that the effort of such a development might be complex and time-consuming, but would nevertheless be a routine undertaking for those of ordinary skill in the art having the benefit of this disclosure.

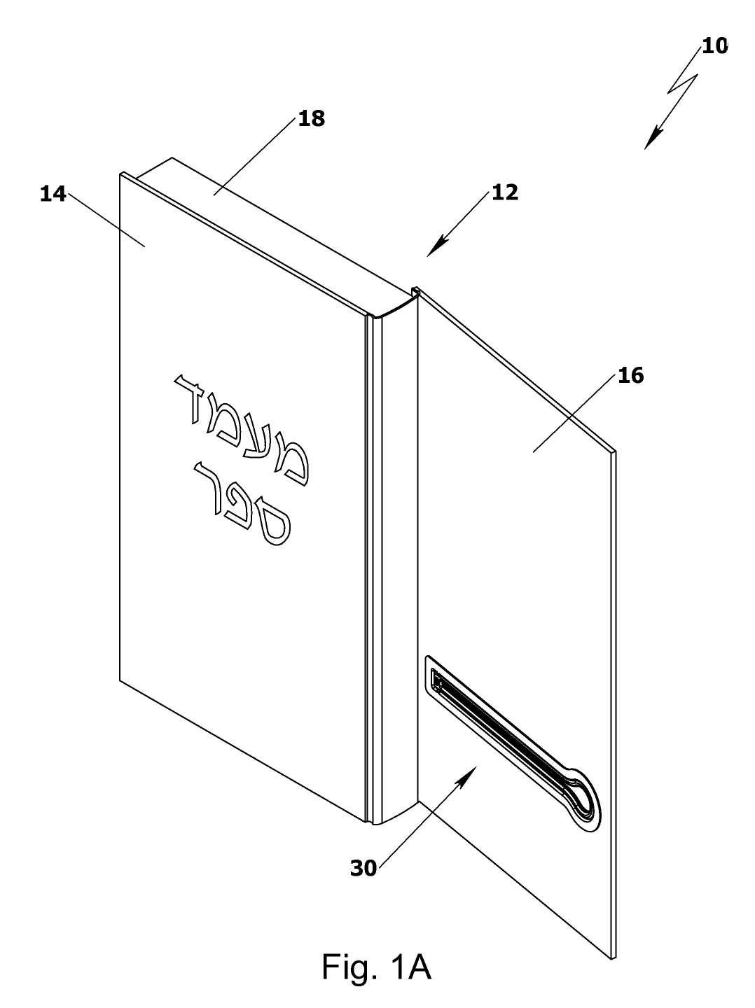

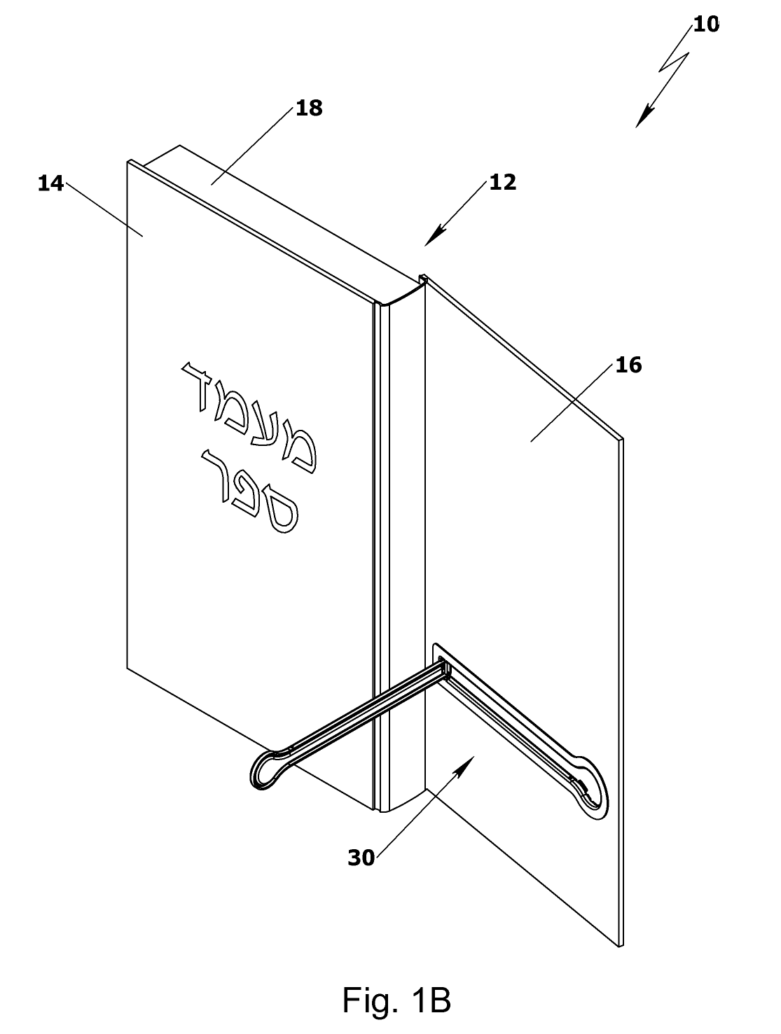

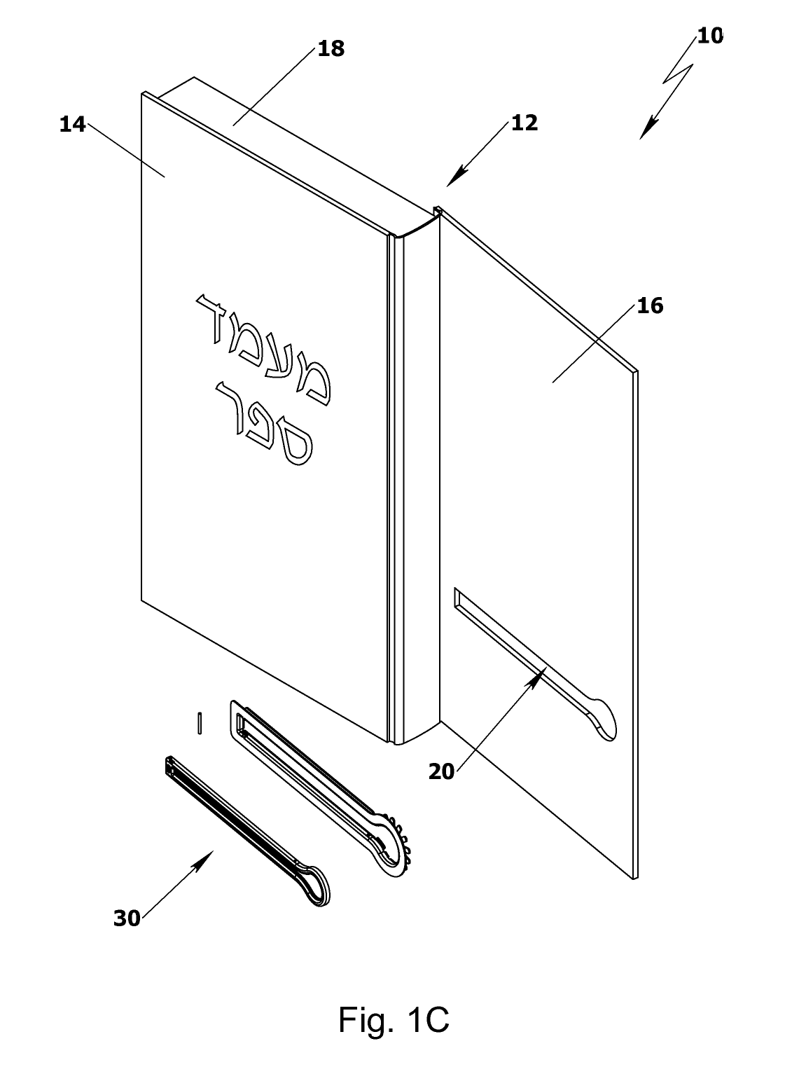

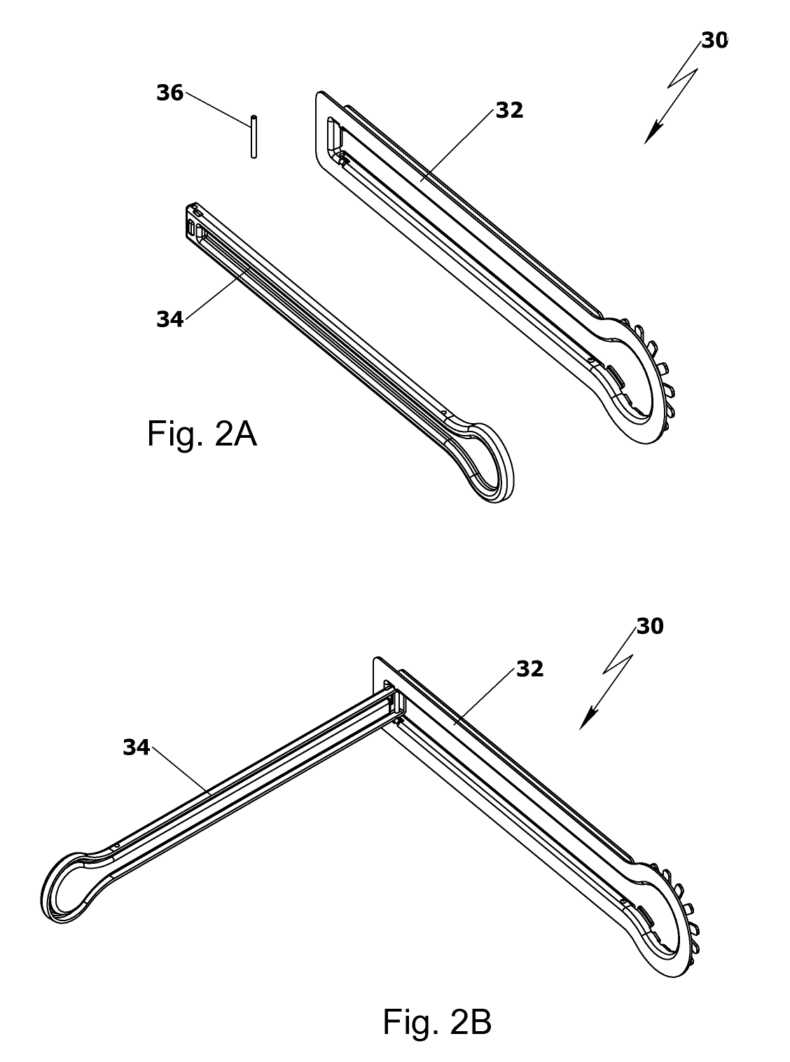

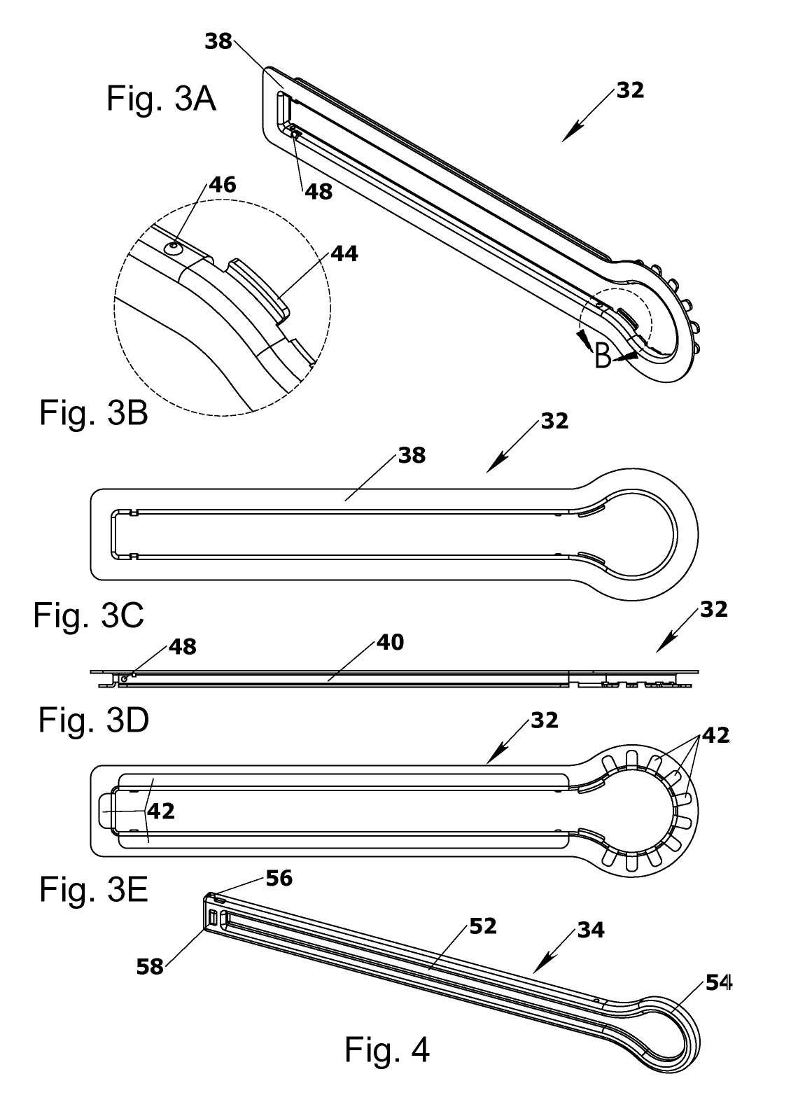

In accordance with some embodiments of the present invention, reference is now made to FIGS. 1A to 4. Assembly 10 comprises book 12 and integral bookstand mechanism 30. Book 12 comprises front hard cover 14 and back hard cover 16, encompassing book pages 18 therebetween. Back hard cover 16 of book 12 comprises structured aperture 20 adapted to accommodate bookstand mechanism 30. In withheld conformation bookstand mechanism 30 assumes an essentially flat shape, wherein the exterior edges of the components of mechanism 30 are substantially coplanar with the faces of back hard cover 16 of book 12, rendering the latter storable in tandem between other books or flat articles (not shown), in withheld conformation of mechanism 30.

Bookstand mechanism 30 comprises integrable frame 32, disposed within structured aperture 20 in back cover 16 of book 12. Support member 34 is pivotally mounted within integrable frame 32, capable of restricted rotation about pivot 36. In deployed support member 34 is protracted relatively to integrable frame 32 at a predetermined angle; thereby rendering book 12 stable in an upright orientation upon slightly slanting assembly 10 backwards. Upon slightly slanting assembly 10 backwards, support member 34 is brought towards the surface front cover and back covers, 14 and 16 respectively, of book 12 supported by, thus providing a additional support point and stabilizing assembly 10 in an essentially upright orientation.

Integrable frame 32 comprises exterior peripheral flange portion 38, adjoined vis-à-vis the surface of back cover 16 of book 12. Integrable frame 32 further comprises interbridging portion 40. Interbridging portion 40 of integrable frame 32 is characterized by that the width thereof essentially matches the respective thickness of back cover 16 of book 12, wherein frame 32 is to be integrated. Integrable frame is furnished with a plurality of wings 42, extending from interbridging portion 40 in a bentable manner. Upon insertion of integrable frame 32 into structured aperture 20 in back cover 16 of book 12, wings 42 are outwardly bent, thereby affixing the former in the latter.

Integrable frame 32 comprises stopper element 44, aimed at limiting the rotation of support member 34 beyond the plane of back cover 16 of book 12. Integrable frame 32 further comprises protrusion 46, aimed at affixing support member 34 in an essentially coplanar orientation relatively to integrable frame 32, in withheld conformation of mechanism 30. Integrable frame 32 includes apertures 48, used to accommodate pivot 36.

Support member 34 comprises extended rectangular portion 52 and apically toroidal portion 54. Rectangular portion 42 comprises aperture 56, used to accommodate pivot 36. Apically toroidal portion 54 is placed on the surface front cover and back covers, 14 and 16 respectively, of book 12 supported by, thus providing a additional support point and stabilizing assembly 10 in an essentially upright orientation. Apically toroidal portion 54 is typically large enough to allow conveniently displacing support member 34 from integrable frame 32, by pushing portion 54 by a finger throughout integrable frame 32 from the inner side of back cover 16 of book 12. Support member 34 further comprises protrusion 56, aimed at limiting the rotation of support member 34 beyond a predetermined angle, and recess 56 used to accommodate protrusion 46 of integrable frame 32; thereby affixing support member 34 in an essentially coplanar orientation relatively to integrable frame 32, in withheld conformation of mechanism 30.

### BEST MODE FOR PRACTICING AND CARRYING OUT THE INVENTION

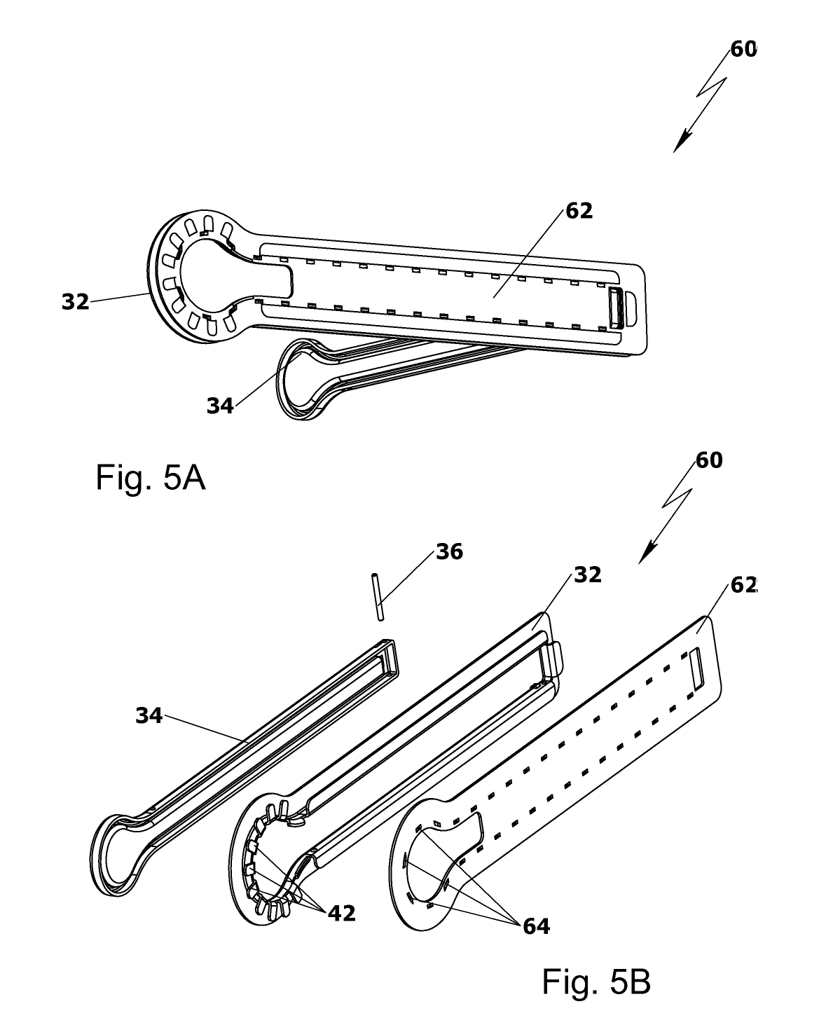

In accordance with some preferred embodiments of the present invention, reference is now made to FIGS. 5A to 5B, showing bookstand mechanism 60. Bookstand mechanism 60 comprises integrable frame 32, disposed within structured aperture 20 in back cover 16 of book 12. Support member 34 is pivotally mounted within integrable frame 32, capable of restricted rotation about pivot 36. Bookstand mechanism 60 further comprises insert 62, having a plurality of apertures 64, therein. Apertures 64, respectively match wings 42 extending from interbridging portion 40 integrable frame 32, whereby upon inserting wings 42 into apertures 64, while insert 62 is adjoined vis-à-vis the interior face of back cover 16 of book 12. Thereafter wings 42 are outwardly bent, thereby affixing mechanism 60 within structured aperture 20 in back cover 16 of book 12, in-between insert 62 and peripheral flange portion of integrable frame 32. Insert 62 substantially obstructs the access through the longitudinal rectangular portion of the aperture in integrable frame 32, leaving the apical toroidal portion of the aperture in integrable frame 32 open for an access of a finger, so as to displace support member 34 from the withheld conformation of mechanism 30.

In another preferred embodiment the integrable frame comprises two moieties (not shown). The interbidging portions of the interlock with each other, exemplarily by a snapping arrangement. Each moiety is appended from another side of the hard back cover of a book and thereafter the interbidging portions thereof interlock with each other; thereby affixing the assembled frame integrated within the hard back cover of a book.

In favor of these who shall engage in experimentation guided by this disclosure, the following preferable numerical values are disclosed. The position of the integrable frame within the respective aperture is preferably from about 10% to about 60% along the longitudinal dimension of the book cover. The length of the supporting element is preferably from about 40% to about 95% relatively to the width of the book cover. The maximal angle of the supporting element relatively the book cover or the integrable frame typically ranges from about 70 degrees to about 120 degrees; whereas the preferable angle is about 90 degrees.

It will be appreciated by persons skilled in the art that the present invention is not limited by what has been particularly shown and described herein above. Rather the scope of the invention is defined by the claims which follow:

1. An integrable bookstand, comprising:
an integrable frame, said frame comprises:
at least one portion adapted to be adjoined to the exterior face of a hard back cover of a book;
at least one portion adapted to be disposed in a respective aperture in said hard back cover of a book;
a support member operationally connected to said integrable frame, said support member comprises:
an elongated portion operationally connected to said integrable frame at first end;
a terminal portion adapted to be placed on the surface the covers of said book are supported by;
said integrable bookstand having a withheld and deployed conformations, wherein:
in said withheld conformation, said support member is substantially coplanar with said hard back cover of said book, thereby rendering the latter storable in tandem between other flat articles;
in said deployed conformation, said support member is extended from said integrable frame, whereby upon slightly slanting said book backwards, said terminal portion of said support member is placed onto the surface said covers of said book are supported by, providing a additional support point and stabilizing said book in an essentially upright orientation.

2. In combination, the integrable bookstand set forth in claim 1 and a book having at least hard back cover, wherein said back comprises a respective aperture adapted to accommodate said integrable frame.

3. The integrable bookstand set forth in claim 1, wherein said support member is pivotally mounted within said integrable frame.

4. The integrable bookstand set forth in claim 1, further comprising a pivot.

5. The integrable bookstand set forth in claim 3, wherein the rotation of said support member is restricted to a predetermined angle.

6. The integrable bookstand set forth in claim 5, wherein said predetermined angle ranges from about 70 to about 120 degrees.

7. The integrable bookstand set forth in claim 1, wherein said support member a portion large enough to allow displacing said support member from said integrable frame, by pushing portion, by a finger throughout said integrable frame.

8. The integrable bookstand set forth in claim 1, wherein in said withheld conformation said bookstand assumes an essentially flat shape, wherein the exterior edges thereof are substantially coplanar with the faces of said back cover of said book, thereby rendering the latter storable in tandem between other flat articles.

9. The integrable bookstand set forth in claim 1, wherein said integrable frame comprises an exterior peripheral flange portion, adjoined vis-à-vis the surface of said back cover of said book.

10. The integrable bookstand set forth in claim 1, wherein said integrable frame comprises interbridging portion is characterized by a width essentially matching the thickness of said back cover of said book.

11. The integrable bookstand set forth in claim 1, wherein said integrable frame is furnished with a plurality of outwardly bentable wings.

12. The integrable bookstand set forth in claim 1, wherein said integrable frame comprises stopper element limiting the rotation of said support member.

13. The integrable bookstand set forth in claim 1, wherein said support member is affixable within said integrable frame.

14. The integrable bookstand set forth in claim 1, wherein said integrable frame comprises further comprising an insert, having a plurality of apertures respectively matching said wings of said integrable frame.

15. The integrable bookstand set forth in claim 14, wherein said insert comprises an aperture open for an access of a finger.

16. The integrable bookstand set forth in claim 1, wherein the position of said integrable frame within said respective aperture ranges from about 10% to about 60% along the longitudinal dimension of said book cover.

17. The integrable bookstand set forth in claim 1, wherein the length of said supporting element ranges from about 40% to about 95% relatively to the width of said book cover.

18. An integrable bookstand, comprising:
an integrable frame adapted to be integrated into a hard back cover of a book;
a support member operationally connected to said integrable frame;
said integrable bookstand having a withheld and deployed conformations, wherein;
in said withheld conformation, said support member is substantially coplanar with said hard back cover of said book, thereby rendering the latter storable in tandem between other flat articles;
in said deployed conformation, said support member is extended from said integrable frame, whereby upon slightly slanting said book backwards, said support member is placed onto the surface said covers of said book are supported by, providing a additional support point and stabilizing said book in an essentially upright orientation.

19. The integrable bookstand set forth in claim 18, wherein said integrable frame is integrated into a respective aperture within said hard back cover of said book.

20. A book comprising at least a hard back cover, wherein said hard back cover comprises an aperture adapted to accommodate an integrable bookstand.
